(19) United States
(12) Patent Application Publication
(10) Pub. No.: US 2025/0308177 A1
(43) Pub. Date: Oct. 2, 2025

(54) PROCESSING SYSTEM, PROCESSING METHOD, AND STORAGE MEDIUM THREOF

(71) Applicant: DENSO CORPORATION, Kariya-city (JP)

(72) Inventors: TEIYU KIMURA, Kariya-city (JP); TASUKU HAYAKAWA, Kariya-city (JP); KEIGO FUJIMOTO, Kariya-city (JP); YUKUN ZHANG, Kariya-city (JP)

(21) Appl. No.: 19/235,301

(22) Filed: Jun. 11, 2025

Related U.S. Application Data
(63) Continuation of application No. PCT/JP2023/038242, filed on Oct. 24, 2023.

(30) Foreign Application Priority Data
Dec. 14, 2022 (JP) 2022-199677

(51) Int. Cl. G06T 19/00; B60W 60/00; G06V 20/52

(52) U.S. Cl. CPC G06T 19/006; B60W 60/001; G06V 20/52

(57) ABSTRACT

A processing system includes a processor that executes a service related process for providing a user service to a user. The processor acquires content information, which includes a service content and a display content, corresponding to an intention of the user based on sensing information of a mobile terminal carried by the user. The processor monitors a background area that configures a display background of the mobile terminal when the user is oriented to the mobile terminal, and provides the user service having a type corresponding to the service content by controlling an autonomous driving apparatus in the background area currently displayed. The mobile terminal displays a background video of the background area in which the autonomous driving apparatus exists, and displays, in a superimposed manner, a cross reality image corresponding to the display content at an existence position of the autonomous driving apparatus in the background video.

### CROSS REFERENCE TO RELATED APPLICATIONS

The present application is a continuation application of International Patent Application No. PCT/2023/038242 filed on Oct. 24, 2023, which designated the U.S. and claims the benefit of priority from Japanese Patent Application No. 2022-199677 filed on Dec. 14, 2022. The entire disclosures of all of the above applications are incorporated herein by reference.

### TECHNICAL FIELD

The present disclosure relates to a processing technology for performing service related process, which is related to a user service provided to a user.

### BACKGROUND

Conventionally, a display device, such as a monitor, a touch panel, or a head mounted display (HMD) displays a content image which is generated by superimposing a virtual object as a display content conforming to a size of a frame image, such as a video.

### SUMMARY

According to an aspect of the present disclosure, a processing system includes at least one processor that executes a service related process related to a user service provided to a user. The at least one processor may acquire content information that recognizes a service content and a display content corresponding to an intention of the user based on sensing information sensed by a mobile terminal carried by the user. The at least one processor may monitor a background area that configures a display background of the mobile terminal when the user is oriented to the mobile terminal. The at least one processor may provide the user service having a type corresponding to the service content out of the content information by performing a driving control of an autonomous driving apparatus in the background area currently displayed. The at least one processor may control the mobile terminal to display a background video of the background area in which the autonomous driving apparatus that provides the user service exists. The at least one processor may control the mobile terminal to display, in a superimposed manner, a cross reality image corresponding to the display content out of the content information at an existence position of the autonomous driving apparatus in the background video.

### BRIEF DESCRIPTION OF DRAWINGS

Features of the present disclosure will become apparent from the following detailed description made with reference to the accompanying drawings. In the drawings:

FIG. 1 is a diagram showing an overall configuration of a network connection environment of a processing system according to a first embodiment;

FIG. 2 is a diagram showing a display state of a mobile terminal according to the first embodiment;

FIG. 3 is a schematic diagram for explaining three-dimensional voxels arranged in an infrastructure system according to the first embodiment;

FIG. 4 is a block diagram showing a processing system according to the first embodiment;

FIG. 5 is a flowchart showing a processing procedure according to the first embodiment;

FIG. 6 is a diagram showing a display state of the mobile terminal according to the first embodiment;

FIG. 7 is a diagram showing a display state of the mobile terminal according to the first embodiment;

FIG. 8 is a perspective view showing a background area of the mobile terminal according to the first embodiment;

FIG. 9 is a perspective view for explaining a drive control pattern of an autonomous driving apparatus according to the first embodiment;

FIG. 10 is a diagram showing a display state of the mobile terminal according to the first embodiment;

FIG. 11 is a diagram showing a configuration of network connection environment of a processing system according to a second embodiment;

FIG. 12 is a diagram showing a display state of a wearable terminal according to the second embodiment;

FIG. 13 is a block diagram showing a processing system according to the second embodiment; and

FIG. 14 is a flowchart showing a processing procedure according to the second embodiment.

### DETAILED DESCRIPTION

The above-described technology is limited to a technology of adopting an avatar as a virtual object for identifying a user in a video distribution service, such as live content. In recent years, a service content, which is provided as a content of user service, has become more diverse and is not limited to distribution service. For example, in smart cities that are planned to be built in countries around the world, service content that works in cooperation with autonomous driving apparatus is expected. At the same time, it is expected that display content will not be limited to avatars for user identification, but will also improve user experience by providing images that match the diversified service contents.

According to a first aspect of the present disclosure, a processing system includes at least one processor that executes a service related process related to a user service provided to a user. The at least one processor: acquires content information that recognizes a service content and a display content corresponding to an intention of the user based on sensing information sensed by a mobile terminal carried by the user; monitors a background area that configures a display background of the mobile terminal when the user is oriented to the mobile terminal; and provides the user service having a type corresponding to the service content out of the content information by performing a driving control of an autonomous driving apparatus in the background area currently displayed. The at least one processor controls the mobile terminal to display a background video of the background area in which the autonomous driving apparatus that provides the user service exists, and display, in a superimposed manner, a cross reality image corresponding to the display content out of the content information at an existence position of the autonomous driving apparatus in the background video.

According to a second aspect of the present disclosure, a processing method is executed by at least one processor to execute a service related process related to a user service provided to a user. The processing method includes: acquiring content information that recognizes a service content and a display content corresponding to an intention of the user based on sensing information sensed by a mobile terminal carried by the user; monitoring a background area that configures a display background of the mobile terminal when the user is oriented to the mobile terminal; providing the user service having a type corresponding to the service content out of the content information by performing a driving control of an autonomous driving apparatus in the background area currently displayed; and displaying, on the mobile terminal, a cross reality image in a superimposed manner at an existence position of the autonomous driving apparatus in a background video, which indicates the background area in which the autonomous driving apparatus that provides the user service exists, the cross reality image corresponding to the display content out of the content information.

According to a third aspect of the present disclosure, a computer-readable non-transitory storage medium stores a processing program including instructions to be executed by at least one processor. The at least one processor executes a service related process related to a user service provided to a user by executing the instructions of the processing program. The instructions includes: acquiring content information that recognizes a service content and a display content corresponding to an intention of the user based on sensing information sensed by a mobile terminal carried by the user; monitoring a background area that configures a display background of the mobile terminal when the user is oriented to the mobile terminal; providing the user service having a type corresponding to the service content out of the content information by performing a driving control of an autonomous driving apparatus in the background area currently displayed; and displaying, on the mobile terminal, a cross reality image in a superimposed manner at an existence position of the autonomous driving apparatus in a background video, which indicates the background area in which the autonomous driving apparatus that provides the user service exists, the cross reality image corresponding to the display content out of the content information.

According to the first to third aspects, the content information that recognizes the service content intended by the user is acquired based on sensing information of the mobile terminal carried by the user. At the same time, the background area, which configures the display background when the user is oriented to the mobile terminal, is monitored. Then, in the background area currently displayed, the user service having a type corresponding to the service content is provided by performing a driving control of the autonomous driving apparatus. Thus, among the diversified user services, it is possible to provide a user service that satisfies user preferences by cooperating with the autonomous driving apparatus.

According to the first to third aspects, the content information that recognizes the display content intended by the user is acquired based on the sensing information of the mobile terminal carried by the user. The mobile terminal displays the background video indicating the background area. In the background area, the autonomous driving apparatus that provides the user service exists in the background area. In the mobile terminal, the cross reality (XR) image corresponding to the display content is superimposed on the existence position of the autonomous driving apparatus. Thus, it is possible to improve user experience by superimposing the XR image corresponding to display content that matches the service content provided by the autonomous driving apparatus.

According to a fourth aspect of the present disclosure, a processing system includes at least one processor that executes a service related process related to a user service provided to a user. The at least one processor: acquires content information that recognizes a service content and a display content corresponding to an intention of the user based on sensing information sensed by a wearable terminal worn by the user; monitors a field of view area viewed by the user through the wearable terminal; and provides the user service having a type corresponding to the service content out of the content information by performing a driving control of an autonomous driving apparatus in the field of view area currently displayed. When the autonomous driving apparatus providing the user service exits in the field of view, the at least one processor controls the wearable terminal to display, in a superimposed manner, a cross reality image corresponding to the display content out of the content information at an existence position of the autonomous driving apparatus.

According to a fifth aspect of the present disclosure, a processing method is executed by at least one processor to execute a service related process related to a user service provided to a user. The processing method includes: acquiring content information that recognizes a service content and a display content corresponding to an intention of the user based on sensing information sensed by a wearable terminal worn by the user; monitoring a field of view area viewed by the user through the wearable terminal; providing the user service having a type corresponding to the service content out of the content information by performing a driving control of an autonomous driving apparatus in the field of view area currently displayed; and displaying, on the wearable terminal, a cross reality image in a superimposed manner at an existence position of the autonomous driving apparatus in the field of view area of the wearable terminal in which the autonomous driving apparatus exists, the cross reality image corresponding to the display content out of the content information.

According to a sixth aspect of the present disclosure, a computer-readable non-transitory storage medium stores a processing program including instructions to be executed by at least one processor. The at least one processor executes a service related process related to a user service provided to a user by executing the instructions of the processing program. The instructions include: acquiring content information that recognizes a service content and a display content corresponding to an intention of the user based on sensing information sensed by a wearable terminal worn by the user; monitoring a field of view area viewed by the user through the wearable terminal; providing the user service having a type corresponding to the service content out of the content information by performing a driving control of an autonomous driving apparatus in the field of view area currently displayed; and displaying, on the wearable terminal, a cross reality image in a superimposed manner at an existence position of the autonomous driving apparatus in the field of view area of the wearable terminal in which the autonomous driving apparatus exists, the cross reality image corresponding to the display content out of the content information.

According to the fourth to sixth aspects, the content information that recognizes the service content intended by the user is acquired based on the sensing information of the wearable terminal worn by the user. At the same time, the field of view viewed by the user who wears the wearable terminal is monitored. Then, in the current field of view, the user service having a type corresponding to the service content is provided by performing a driving control of the autonomous driving apparatus. Thus, among the diversified user services, it is possible to provide a user service that satisfies user preferences by cooperating with the autonomous driving apparatus.

According to the fourth to sixth aspects, the content information that recognizes the display content intended by the user is also acquired based on the sensing information of the wearable terminal worn by the user. The wearable terminal displays the field of view of the wearable terminal. The autonomous driving apparatus that provides the user service exists in the field of view of the wearable terminal. In the wearable terminal, an XR image corresponding to the display content is superimposed on the existence position of the autonomous driving apparatus. Thus, it is possible to improve user experience by superimposing the XR image corresponding to the display content that matches the service content provided by the autonomous driving apparatus.

The following will describe embodiments of the present disclosure with reference to the drawings. It should be noted that the same reference symbols are assigned to corresponding components in the respective embodiments, and repeated descriptions may be omitted. When only a part of the configuration is described in one embodiment, the configurations of other embodiments described above can be applied to remaining part of the configuration. Further, not only the combinations of the configurations explicitly shown in the description of the respective embodiments, but also the configurations of the multiple embodiments can be partially combined together even if the configurations are not explicitly shown if there is no difficulty in the combination in particular.

### First Embodiment

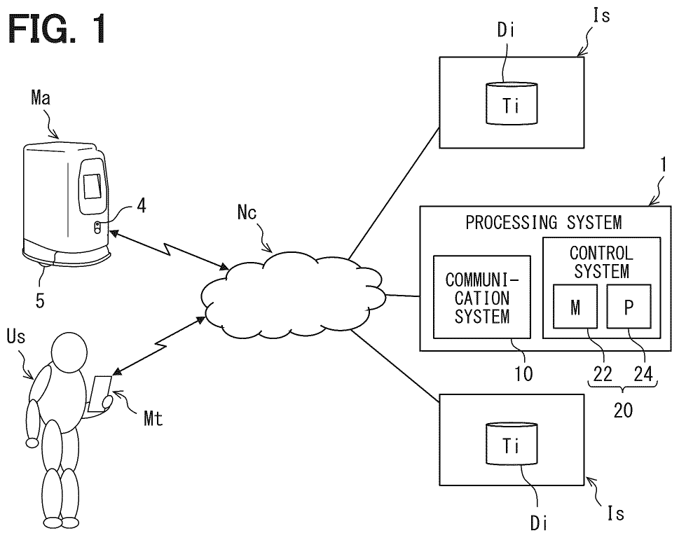

FIG. 1 shows a processing system 1 according to a first embodiment, the processing system 1 executes a service related process, which is related to a user service provided to a user Us. The processing system 1 is connected, via a communication network Nc, to a mobile terminal Mt carried by a pre-registered user Us, an autonomous driving apparatus Ma that moves by autonomous driving, and an infrastructure system Is that provides infrastructure information. The number of each connection element Mt, Ma, Is connected with the processing system 1 is assumed as at least one.

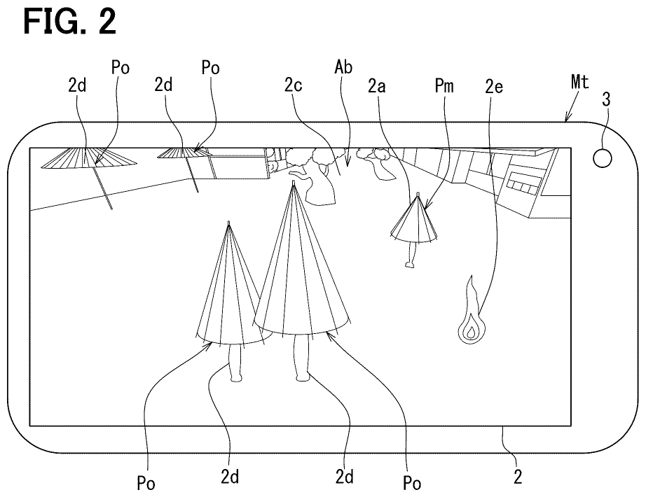

As shown in FIG. 1 and FIG. 2, when the mobile terminal Mt is in connected state with the processing system 1, the mobile terminal Mt can be carried and operated by a user Us of the processing system 1 with his/her hands or fingers. The mobile terminal Mt is a compact-type electronic device equipped with a display unit 2 and a sensor unit 3. For example, the mobile terminal Mt may be a smartphone or a tablet terminal. The mobile terminal Mt controls transmission and reception of data via the communication network Nc using a communication unit. The mobile terminal Mt is controlled by a control unit in accordance with a control command, which is from the processing system 1 via the communication network Nc, so as to cooperate with the processing system 1 to execute the service related process.

Under an operation control of the control unit of the mobile terminal Mt, the display unit 2, such as a liquid crystal panel or an organic EL panel displays a content necessary for service related process as shown in FIG. 2. Under an operation control of the mobile terminal Mt, the sensor unit 3 acquires sensing information by performing a sensing process corresponding to the service related process. The sensor unit 3 may be provided by at least one of a camera, an inertial sensor, a Global Navigation Satellite System (GNSS) sensor, a touch sensor, a microphone, or the like. With this configuration, the sensor unit 3 is able to acquire input from the user Us, which indicates the intention of the user Us, as the sensing information.

The autonomous driving apparatus Ma shown in FIG. 1 is an autonomous vehicle or a robot that can autonomously move in any direction, forward, backward, left or right, by electrically driving wheels 5 based on the sensing information from the sensor unit 4. The autonomous driving apparatus Ma controls the transmission and reception of data via the communication network Nc using a communication unit. The autonomous driving apparatus Ma is driven and controlled by a control unit in accordance with control commands transmitted from the processing system 1 via the communication network Nc so as to cooperate with the processing system 1 to carry out service related process. Under this drive control, the sensor unit 4 acquires sensing information by performing a sensing process corresponding to the service related process. The sensor unit 4 may be provided by at least one of a camera, an inertial sensor, a GNSS sensor, a LIDAR (Light Detection and Ranging/Laser Imaging Detection and Ranging), a sonar, or the like.

The infrastructure system Is is a platform system that shares three-dimensional spatial information Ti stored in an infrastructure database Di as a common platform for a distributed architecture. The infrastructure system Is controls the transmission and reception of data via the communication network Nc by a communication unit. The infrastructure system Is collects, using a control unit, three-dimensional spatial information Ti, which is provided to individual distributed systems such as the processing system 1 constituting the distributed architecture, and updates the information stored in the infrastructure database Di to the latest information.

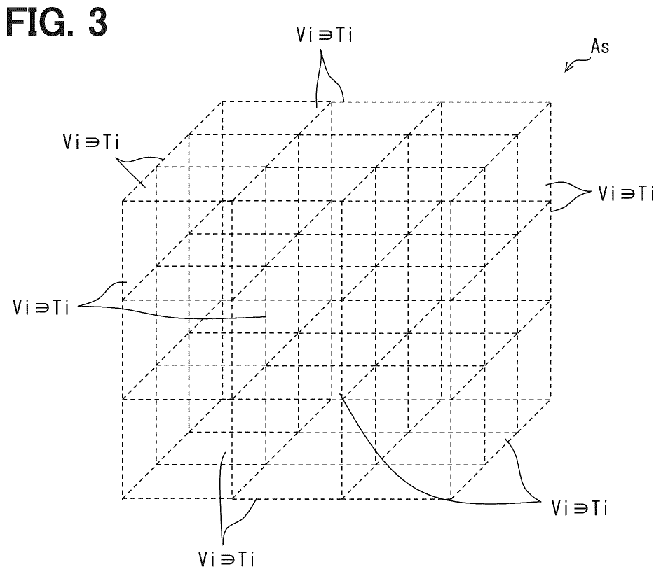

The infrastructure system Is manages information by virtually dividing the three-dimensional space, in which information is to be stored, into multiple three-dimensional voxels Vi (that is, three-dimensional grids) arranged in a three-dimensional array as shown in FIG. 3. The infrastructure system Is accumulates a data set correlated to a metadata for each space ID individually assigned to each voxel Vi, as three-dimensional spatial information Ti in an infrastructure database Di shown in FIG. 1. The three-dimensional spatial information Ti may include two-dimensional grid information that correlated, for example, only to the lower surface of the voxel Vi that constitutes the bottom layer of the two-dimensional array along the ground surface in the three-dimensional array.

The data constituting the three-dimensional spatial information Ti may be collected from at least one of the mobile terminal Mt that cooperates with the processing system 1, other mobile terminals, or wearable terminals such as an HMD or smart glasses. The data constituting the three-dimensional spatial information Ti may be collected from at least one of the autonomous driving apparatus Ma that cooperates with the processing system 1 or another mobile object. The data constituting the three-dimensional spatial information Ti may be collected from at least one of the following types of infrastructure sensors, such as a communication base station, a smart pole, and a smart streetlight, each of which including a camera and/or a LiDAR. The data constituting the three-dimensional spatial information Ti may be collected from a service provider providing at least one of the following services: map service, weather service, communication service, traffic management service, planimetric feature management service, aviation management service, and user services to be described below that is handled by the processing system 1.

The construction data collected in the above-described manner to construct the three-dimensional spatial information Ti may be at least one type of image data among, for example, a video, a still image, or a point cloud image. The construction data of the three-dimensional spatial information Ti may be at least one type of secondary data that ensures information security, such as position data, movement data, posture data, line of sight data, behavior data, and people flow data generated regarding humans that include the user Us of the processing system 1, within the target space for information accumulation by image processing of such image data, as well as intention data representing the intention of the user Us, which will be described later. The construction data of the three-dimensional spatial information Ti may be at least one type of secondary data, such as position data, movement data, and posture data, generated by image processing of image data regarding human carry-on items, including the mobile terminal Mt carried by the user Us, within the information accumulation target space. The construction data of the three-dimensional spatial information Ti may be at least one type of secondary data, such as position data, movement data, and posture data, generated by image processing of image data regarding a mobile object including the autonomous driving apparatus Ma within the information accumulation target space.

The construction data of the three-dimensional spatial information Ti may be voice data obtained by collecting voices of people, which include the user Us of the processing system 1, within the information accumulation target space. The construction data of the three-dimensional spatial information Ti may be at least one type of secondary data that ensures information security, such as position data, movement data, behavior data, people flow data, and conversation data analyzed regarding humans including the user Us through voice recognition processing of such voice data, as well as intention data that represents the intention of the user Us, as to be described below. The construction data of the three-dimensional spatial information Ti may be at least one of the following data: two-dimensional and/or three-dimensional map data, GIS (Geographic Information System) data, road network data, weather data, communication data, communication line data, traffic data, feature management data, BIM (Building Information Modelling) data, POI (Point of Interest) data, aviation management data, or time data. The construction data of the three-dimensional spatial information Ti may be service data related to at least one of the user services handled by the processing system 1, which will be described later, such as a photography service, a trash can guidance service, a delivery service, or a guidance service.

As shown in FIG. 1, the processing system 1 is a distributed computer system, and includes a communication system 10 and a control system 20. The processing system 1 is constructed to include at least one of, for example, a cloud server or an edge server. At least a part of each system 10, 20 included in the processing system 1 may be constituted by a communication unit and a control unit of the mobile terminal Mt. At least a part of each system 10, 20 included in the processing system 1 may be constituted by a communication unit and a control unit of the autonomous driving apparatus Ma. At least a part of each system 10, 20 included in the processing system 1 may be constituted by a communication unit and a control unit of the infrastructure system Is.

The communication system 10 includes a communication device for constructing the communication network Nc. The control system 20 is connected to the communication system 10 via a wired communication line or a wireless communication line. The control system 20 includes at least one dedicated computer. The dedicated computer included in the control system 20 has at least one memory 22 and at least one processor 24.

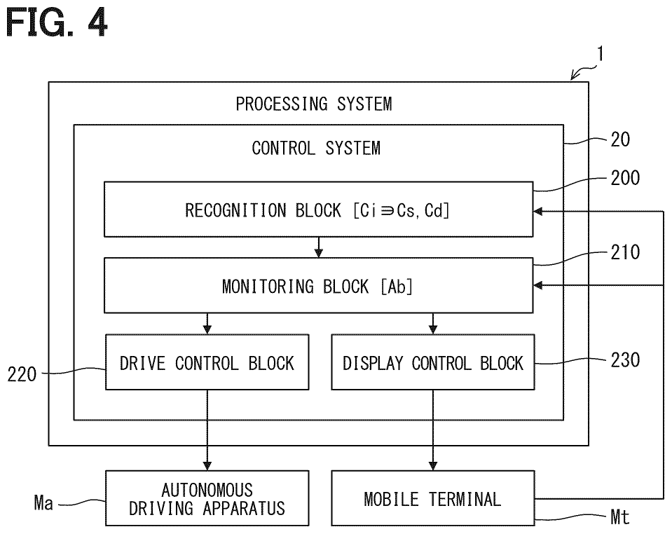

In such a processing system 1, the control system 20 executes, with the at least one processor 24, multiple instructions of a processing program stored in a memory 22. The control system 20 includes multiple functional blocks constructed for carrying out service related process related to the user service provided to the user Us. The functional blocks include a recognition block 200, a monitoring block 210, a drive control block 220, and a display control block 230, as shown in FIG. 4.

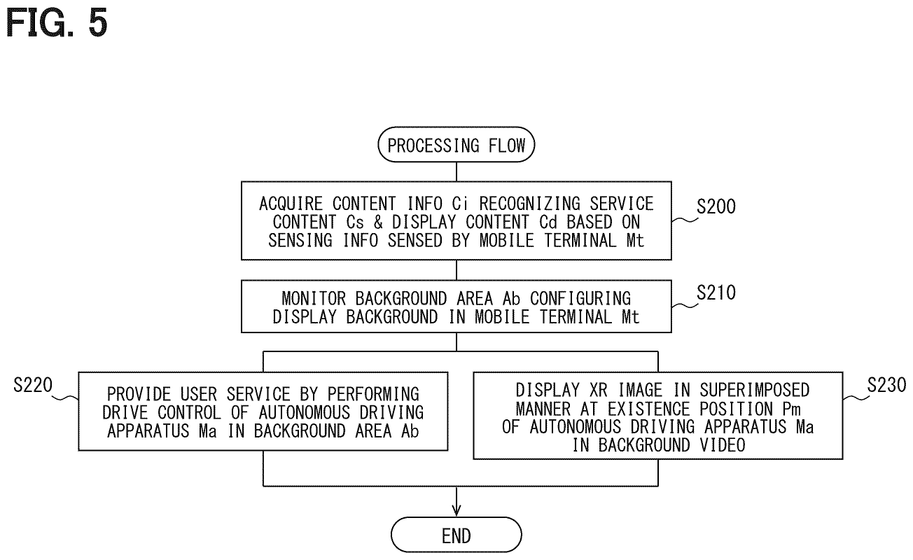

The processing method by which the processing system 1 executes service related process in cooperation with the functional blocks 200, 210, 220, and 230 is shown in FIG. 5 as a processing flow. The processing flow is executed in response to the sensor unit 3 of the mobile terminal Mt acquiring, as the sensing information, a service request input indicating an intention of the user Us to request provision of user service. The symbol “S” in the processing flow represents each step executed by a corresponding instruction included in the processing program of the first embodiment.

In S200 of the processing flow, the recognition block 200 (see FIG. 4) acquires content information Ci that recognizes the service content Cs intended by the user Us and a display content Cd, based on the sensing information of the mobile terminal Mt carried by the user Us. The service content Cs recognized in S200 refers to the type of user service that can be provided to the user Us of the processing system 1. In the first embodiment, as types of user services corresponding to the service content Cs, at least two types are prepared from: a photography service, a trash can guidance service, a delivery service, or a guidance service.

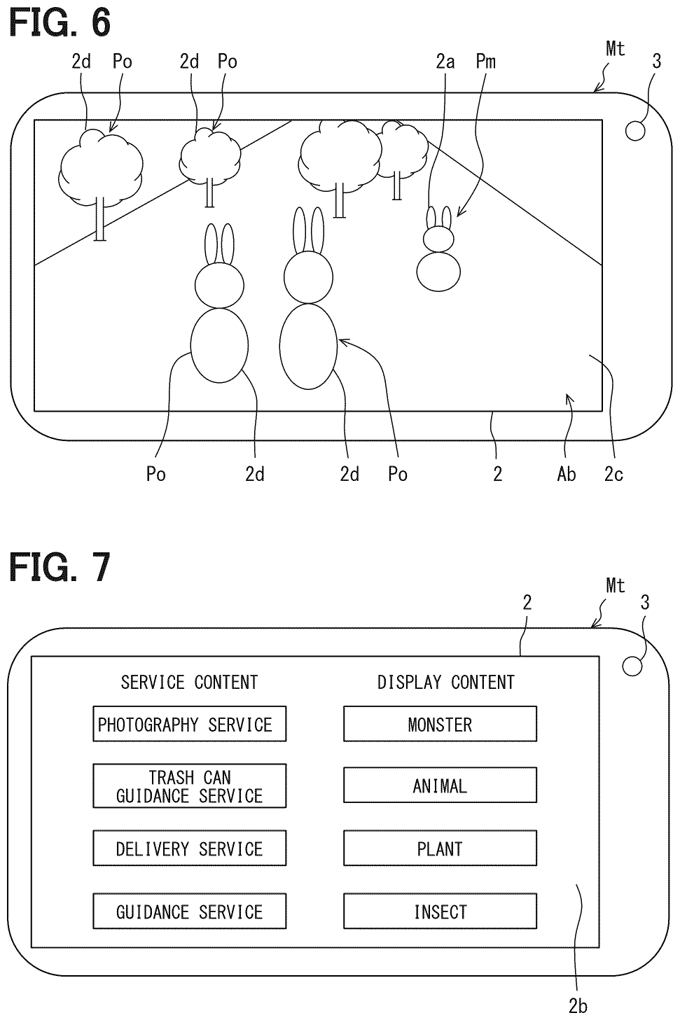

The display content Cd recognized in S200 refers to the type of XR image 2a among the XR images 2a, 2d, and 2e to be displayed on the display unit 2 of the mobile terminal Mt corresponding to the service content Cs as shown in FIG. 2 and FIG. 6 when the user service is provided to the user. The XR image 2a, in which the type intended by the user Us is recognized as the display content Cd, is provided with multiple types of character images, which are two-dimensional or three-dimensional representations of virtual or real creatures such as monsters, animals, plants, and insects. The XR images 2d and 2e, which are given a common theme corresponding to the type of XR image 2a, are provided with multiple types of character images that represent virtual or real living things such as monsters, animals, plants, and insects, as well as inanimate objects such as prehistoric buildings, service vehicles, and imaginary objects, in two or three dimensions.

In S200 of FIG. 5, sensing information for recognizing the service content Cs and the display content Cd is input to the sensor unit 3 as the intention of the user Us, and is acquired via the mobile terminal Mt. An input acceptance image 2b for accepting touch input by the sensor unit 3 as a selection input from the user Us of the service content Cs and the display content Cd may be displayed on the display unit 2 of the mobile terminal Mt as shown in FIG. 7. As the selection input of the service content Cs or the display content Cd from the user Us, a gesture input, a line of sight input, a facial expression input, or a voice input performed by the user Us may be sensed by the sensor unit 3. Such gesture input, line of sight input, facial expression input, or voice input may be recognized based on three-dimensional spatial information Ti obtained from the infrastructure database Di.

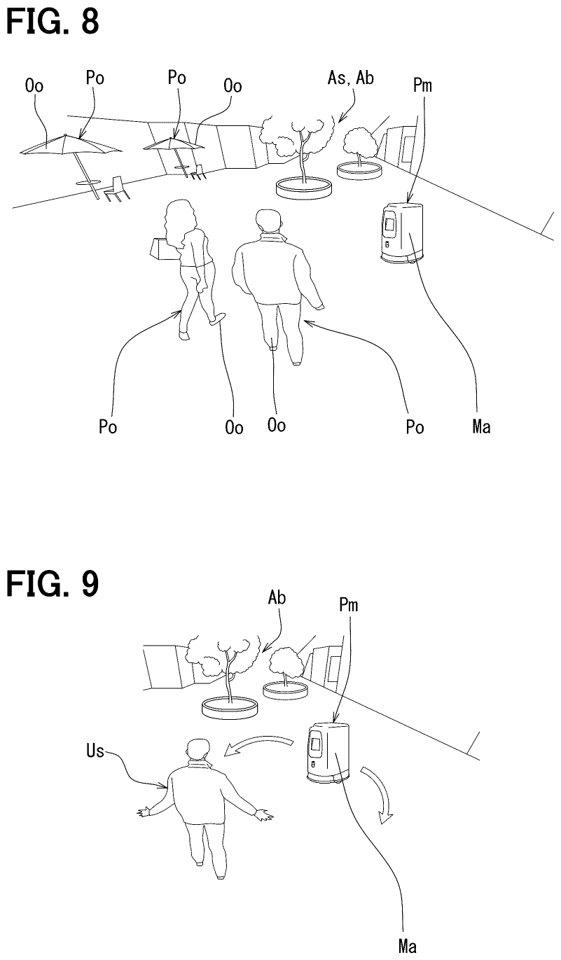

In S210 of the processing flow shown in FIG. 5, the monitoring block 210 (see FIG. 4) monitors a background area Ab that configures the display background of the XR image 2a on the display unit 2 as shown in FIG. 8 when the user Us is oriented to the mobile terminal Mt. In the background area Ab, a service space As in which a user service of a type corresponding to the service content Cs is provided as shown in FIG. 8 is monitored within the information accumulation target space in which multiple voxels Vi are arranged in the infrastructure system Is as shown in FIG. 3. Therefore, monitoring of the background area Ab along a direction in which the mobile terminal Mt is facing is performed based on at least one of, for example, camera information and inertial information, or the like, among sensing information sensed by the sensor unit 3 of the mobile terminal Mt.

In S220 of the processing flow shown in FIG. 5, the drive control block 220 (see FIG. 4) provides a user service of type corresponding to the service content Cs out of the content information Ci by controlling the drive of the autonomous driving apparatus Ma in the current background area Ab. At this time, a drive control pattern of the autonomous driving apparatus Ma that matches the service content Cs is read from the memory 22, and the user service is provided according to the drive control pattern.

The photography service by S220 is provided by the drive control pattern in which the autonomous driving apparatus Ma having an image capturing unit is driven from a waiting position to a position in front of the user Us or to a landmark in the vicinity of the user Us, photographs the user Us at a position around the user Us, and then returns to the waiting position. In the photography service, the photography timing or photography period may be presented to the user Us by audio output from an audio unit included in the autonomous driving apparatus Ma. In the photography service, the photography timing or photography period may be presented to the user Us by display output from a display unit possessed by the autonomous driving apparatus Ma.

In the photography service, two-dimensional or three-dimensional still images or videos may be captured to include the user Us by the autonomous driving apparatus Ma that is driven around a user Us as illustrated by the white arrow in FIG. 9. In the photography service, the focus during photography may be adjusted based on the distance, which is sensed by a sensor unit 4 of LiDAR included in the autonomous driving apparatus Ma, from the user Us to the autonomous driving apparatus Ma. In the photography service, the incident direction of external light during photography may be adjusted based on three-dimensional spatial information Ti obtained from the infrastructure database Di, or sensing information from a sensor unit 4 such as a camera included the autonomous driving apparatus Ma.

The trash can guidance service in S220 is provided by a drive control pattern in which the autonomous driving apparatus Ma holding a trash can is driven from a waiting position to a position directly in front of a user Us, and after receiving disposal of the trash performed by the user Us in the trash can, the autonomous driving apparatus Ma returns to the waiting position. The trash can guidance service may instruct the user Us to dispose of trash in the trash can by an audio instruction output from an audio unit included in the autonomous driving apparatus Ma. In the trash can guidance service, the user Us may be instructed to dispose of trash in the trash can by an instruction displayed on a display unit included in the autonomous driving apparatus Ma.

The delivery service in S220 is provided by a drive control pattern in which the autonomous driving apparatus Ma holding a delivery box is driven from a waiting position to a position directly in front of a user Us, and then returns to the waiting position after accepting loading of a package into the delivery box performed by the user Us. In the delivery service, the user Us may be instructed to load the package into the delivery box by an audio instruction output from an audio unit included in the autonomous driving apparatus Ma. In the delivery service, the user Us may be instructed to load the package into the delivery box by an instruction displayed on a display unit included in the autonomous driving apparatus Ma.

The guidance service in S220 is provided by a drive control pattern in which the autonomous driving apparatus Ma is driven from a waiting position to a position directly in front of a target person to be guided, such as the user Us or a registered family member of the user Us, performs route guidance to lead the target person, and then returns to the waiting position. In the guidance service, the route along which the target person should be guided may be instructed by an audio instruction output from an audio unit included in the autonomous driving apparatus Ma. In the guidance service, the route along which the target person should be guided may be indicated by an instruction displayed on a display unit included in the autonomous driving apparatus Ma. Prior to such route instruction, the mobile terminal Mt may display an input acceptance image on the display unit 2 to accept input from the user Us about route related information, such as the destination and/or the transportation method, via the sensor unit 3. In the route instruction, the autonomous driving apparatus Ma may perform a drive control pattern in which the luggage carried by the target person is stored and transported in a delivery box of the autonomous driving apparatus Ma.

The following will describe S230 that is executed in parallel with S220 in the processing flow of FIG. 5. In S230, the display control block 230 (see FIG. 4) displays the background video 2c of the background area Ab in which the autonomous driving apparatus Ma providing the user service in S220 exists, as shown in FIG. 8 and FIG. 9, on the display unit 2 of the mobile terminal Mt as shown in FIG. 2 and FIG. 6. The background video 2c is acquired based on sensing information obtained by the sensor unit 4 such as a camera, or based on three-dimensional spatial information Ti acquired from the infrastructure database Di. The background video 2c may be primary video data captured in the background area Ab, or secondary video data in which processing has been applied to a part of the primary data, such as the ground or sky.

In S230 of FIG. 5, the display control block 230 superimposes an XR image 2a corresponding to the display content Cd out of the content information Ci on the position Pm of the autonomous driving apparatus Ma in the background video 2c displayed on the display unit 2 as shown in FIG. 2 and FIG. 6. The superimposed display position of the XR image 2a is adjusted to match the existence position Pm on the background video 2c in accordance with the drive control pattern of the autonomous driving apparatus Ma in S220. As a result, the XR image 2a is displayed in place of the position Pm of the autonomous driving apparatus Ma on the background video 2c.

In S230, the display control block 230 superimposes and displays the XR image 2d, as shown in FIG. 2 and FIG. 6, on the existence position Po of another object Oo that exists in the background area Ab together with the autonomous driving apparatus Ma, as shown in FIG. 8. The superimposed display position of the XR image 2d is adjusted according to the position Po of another object Oo. The another object Oo whose existence position Po on the background video 2c is replaced by the XR image 2d is at least one of the following: a person other than the user Us of the processing system 1, a moving body other than the autonomous driving apparatus Ma cooperating with the processing system 1, and a planimetric feature, or the like.

In S230, the display control block 230 obtains three-dimensional spatial information Ti from the infrastructure database Di, to which position related information relating to each of the positions Pm, Po of the autonomous driving apparatus Ma and another object Oo has been added for multiple voxels Vi virtually divided into the service space As as shown in FIG. 3. In S230, the display control block 230 displays the XR images 2a and 2d in a superimposed manner at each of the positions Pm and Po based on the obtained three-dimensional spatial information Ti. In the first embodiment, character images related to the display content Cd out of the content information Ci are superimposed and displayed as the XR images 2a and 2d at the respective existence positions Pm and Po.

In S230, the display control block 230 may superimpose and display the XR image 2e, as shown in FIG. 2, on scenery in the background area Ab other than the respective positions Pm, Po of the autonomous driving apparatus Ma and another object Oo. In the first embodiment, the character image related to the display content Cd may be displayed in a superimposed manner as the XR image 2e. The superimposed display position of the XR image 2e may be adjusted based on the three-dimensional spatial information Ti obtained from the infrastructure database Di so that it does not overlap with respective superimposed positions of the XR images 2a and 2d.

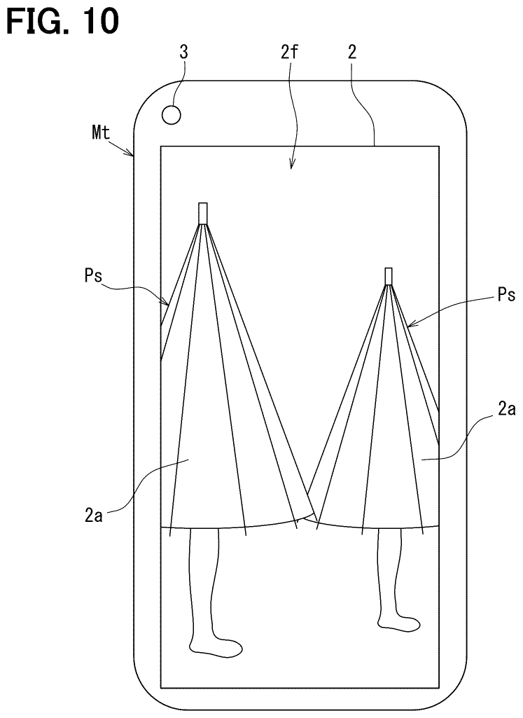

During the photography service performed in S230, the background video 2c in which at least XR images 2a, 2d are superimposed at the position Pm of the autonomous driving apparatus Ma driven to photograph the user Us and the position Po of the periphery object Oo is displayed and output to the user Us. A still image or a video as the captured image 2f of the user Us and the user's background area shown in FIG. 9 is switched from the background video 2c of FIG. 2 and displayed as shown in FIG. 10, so that the XR image 2a may be superimposed on the existence position Ps of at least the former of the user Us and the user's companion in the captured image 2f. In this way, image data in which the XR image 2a is superimposed on the captured image 2f capturing the user Us and the background area may be stored in a storage medium provided inside or outside the mobile terminal Mt.

During the trash can guidance service performed in S230, a background video 2c in which at least XR images 2a, 2d are superimposed on the position Pm of the autonomous driving apparatus Ma, which is driven to receive trash disposal from the user Us, and the position Po of the periphery object Oo are displayed and output to the user Us. The XR image 2a corresponding to the autonomous driving apparatus Ma may be a character image in which the disposal opening of a trash can resembles the mouth of a living creature. The XR image 2a corresponding to the autonomous driving apparatus Ma may include an indication image that indicates which of multiple disposal outlets of the trash can corresponds to the type of trash to being disposed.

During the delivery service performed in S230, the background video 2c in which at least XR images 2a, 2d are superimposed on the position Pm of the autonomous driving apparatus Ma, which is driven to receive loading of package from the user Us, and the position Po of the periphery object Oo are displayed and output to the user Us. The XR image 2a corresponding to the autonomous driving apparatus Ma may be a character image in which the loading opening of the delivery box resembles the mouth of a living creature.

During the guidance service performed in S230, the background video 2c in which at least XR images 2a, 2d are superimposed on the position Pm of the autonomous driving apparatus Ma that is driven to guide the target person and the position Po of the periphery object Oo are displayed and output to the target person. A still image or video as a captured image of the background area of the route to be guided may be displayed in place of the background video 2c. Image data of the captured image of the background area of the guidance route in this manner may be stored in an internal or external storage medium of the mobile terminal Mt.

The processing flow of the first embodiment shown in FIG. 5 is completed when the provision of the user service according to the service content Cs out of the content information Ci is completed in S220 or S230. Thereafter, in response to the next service request input being acquired through the sensor unit 3 of the mobile terminal Mt, the next execution of the processing flow is started.

### (Effects)

The effects of the first embodiment explained so far will be described below.

According to the first embodiment, content information Ci that recognizes service content Cs designated by a user Us is acquired based on the sensing information of mobile terminal Mt carried by the user Us. The background area Ab, which becomes the display background when the user Us is oriented to the mobile terminal Mt, is monitored. Thus, a user service of a type corresponding to the service content Cs is provided by driving and controlling the autonomous driving apparatus Ma in the current background area Ab. Thus, even among the diversified user services, it is possible to provide a user service that satisfies the user's preferences by cooperating with the autonomous driving apparatus Ma.

According to the first embodiment, the content information Ci that recognizes the display content Cd the user Us intends to display is also acquired based on the sensing information of the mobile terminal Mt. Therefore, in the mobile terminal Mt that displays the background video 2c of the background area Ab in which the autonomous driving apparatus Ma that provides user services is located as described above, the XR image 2a corresponding to the display content Cd is superimposed on the position Pm of the autonomous driving apparatus Ma. This means that it is possible to increase the satisfaction of the user's preferences by superimposing the XR image 2a according to the display content Cd that matches the service content Cs provided by the autonomous driving apparatus Ma.

According to the first embodiment, the XR image 2d is also superimposed and displayed at the existence position Po of another object Oo that exists in the background area Ab together with the autonomous driving apparatus Ma. This configuration enables superimposed display of XR images 2a, 2d corresponding to display content Cd that matches the service content Cs provided by the autonomous driving apparatus Ma over a wide range of the background video 2c of the background area Ab, thereby further increasing user experience.

According to the first embodiment, three-dimensional spatial information Ti to which position related information relating to each of the positions Pm, Po of the autonomous driving apparatus Ma and another Oo is added is obtained from an infrastructure database Di for multiple three-dimensional voxels Vi virtually divided into a service space As in which user services are provided. Therefore, at the respective positions Pm, Po of the autonomous driving apparatus Ma and another object Oo based on the acquired three-dimensional spatial information Ti, the XR images 2a, 2d that can satisfy the user preferences in the background video 2c of the background area Ab can be replaced at appropriate positions and superimposed. Therefore, it is possible to further improve user experience while suppressing the discomfort felt by the user due to misalignment of the superimposed display.

According to the first embodiment, the user service is provided by a drive control pattern of the autonomous driving apparatus Ma that is matched to the service content Cs out of the content information Ci. This configuration further improves user experience through operation of the autonomous driving apparatus Ma in coordination with the user service. Additionally, according to the first embodiment, the superimposed display position of the XR image 2a with respect to the background video 2c is adjusted in accordance with the position Pm of the autonomous driving apparatus Ma that follows the drive control pattern. According to this configuration, the XR image 2a corresponding to the display content Cd that matches the service content Cs can be superimposed on the background video 2c in accordance with the operation of autonomous driving apparatus Ma, thereby enabling further improvement of user experience. In the first embodiment, by being based on three-dimensional spatial information Ti from the infrastructure database Di, the tracking ability of the XR image 2a in response to the operation of the autonomous driving apparatus Ma can be improved, and it is also possible to improve the effect of suppressing user discomfort caused by positional misalignment of the superimposed display.

According to the first embodiment, character images related to the display content Cd out of the content information Ci are superimposed and displayed as the XR images 2a and 2d on the positions Pm and Po of the autonomous driving apparatus Ma and another object Oo. This configuration enables the character image that can satisfy the user's preferences in the background video 2c of the background area Ab to be displayed instead of the autonomous driving apparatus Ma and another object Oo, and be visible to the user Us. Therefore, it is possible to increase the degree of satisfaction of the user's preferences, particularly with respect to the display content Cd.

### Second Embodiment

The following will describe a second embodiment, which is a modification example of the first embodiment.

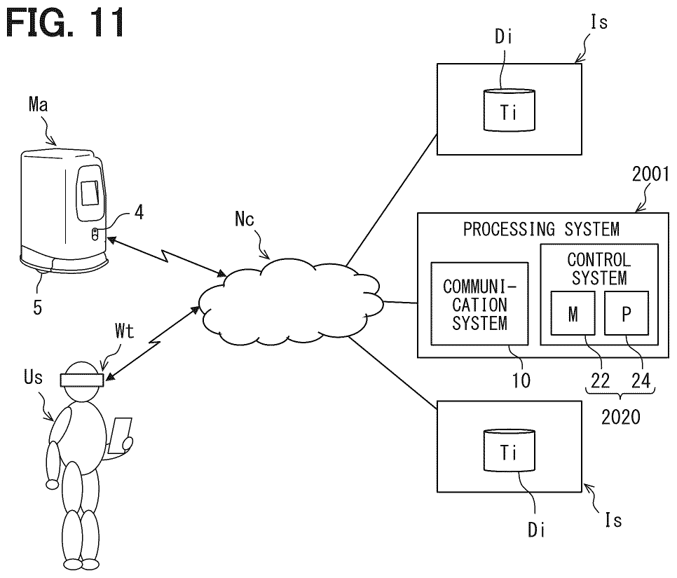

As shown in FIG. 11, a processing system 2001 of the second embodiment is connected to a wearable terminal Wt worn by a pre-registered user Us, an autonomous driving apparatus Ma, and an infrastructure system Is, via a communication network Nc. The number of each connection element Wt, Ma, Is connected with the processing system 1 is assumed as at least one. As explained in the first embodiment, the mobile terminal Mt carried by the user Us may be connected to the processing system 2001 via the communication network Nc, or may be disconnected from the processing system 2001.

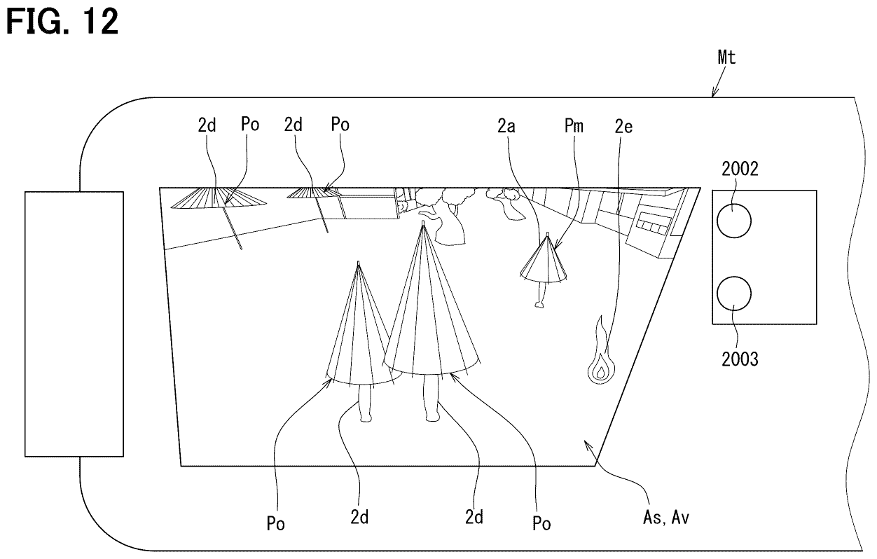

The wearable terminal Wt is configured so that, at least when connected to the processing system 2001, a user Us of the processing system 2001 can wear it on his/her face and operate it in a hands-free manner. As shown in FIG. 12, the wearable terminal Wt is an optical see-through electronic device equipped with a display unit 2002 and a sensor unit 2003. For example, the wearable terminal Wt may be an HMD or smart glasses. The wearable terminal Wt controls data transmission and reception via the communication network Nc using a communication unit. The wearable terminal Wt is operated and controlled by a control unit in accordance with control commands from the processing system 2001 via the communication network Nc so as to cooperate with the processing system 2001 to execute service related process. FIG. 12 is a schematic image diagram showing how the field of view area Av appears from the user Us in a portion corresponding to one of both eyes of the user Us when the user wears the wearable terminal Wt.

Under an operation control by the control unit of the wearable terminal Wt, the virtual image projection type or retinal projection type display unit 2002 superimposes a display necessary for service related process on the real image of the field of view area Av viewed by the user Us through, for example, glasses or lenses, as shown in FIG. 12, such that the user Us can view the image after superimposition. Under the operation control of the wearable terminal Wt, the sensor unit 2003 acquires sensing information by performing a sensing process corresponding to the service related process. The sensor unit 2003 may be at least one of a camera, an inertial sensor, a GNSS sensor, an electrooculography sensor, a line of sight sensor, an infrared sensor, a geomagnetic sensor, a motion sensor, a touch sensor, and a microphone. With this configuration, the sensor unit 2003 is able to acquire input from the user Us, which indicates the intention of the user Us, as the sensing information.

The autonomous driving apparatus Ma shown in FIG. 11 is configured in the same manner as the first embodiment, except that it is driven and controlled by a control unit in accordance with control commands from the processing system 2001 via THE communication network Nc so as to perform service related process in cooperation with the processing system 2001. A control system 2020 of the processing system 2001 is configured in the same manner as the control system 20 of the first embodiment, except that at least a part of the control system may be constituted by a control unit of the wearable terminal Wt, and that it executes a processing flow using the wearable terminal Wt with the functional block configuration to be described below.

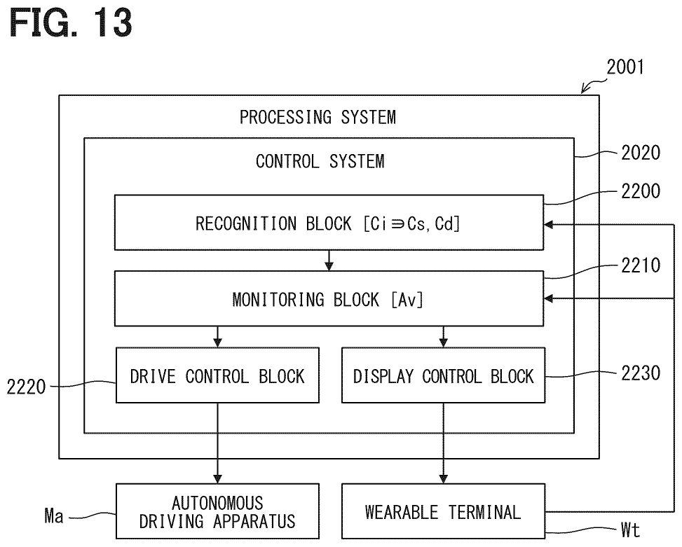

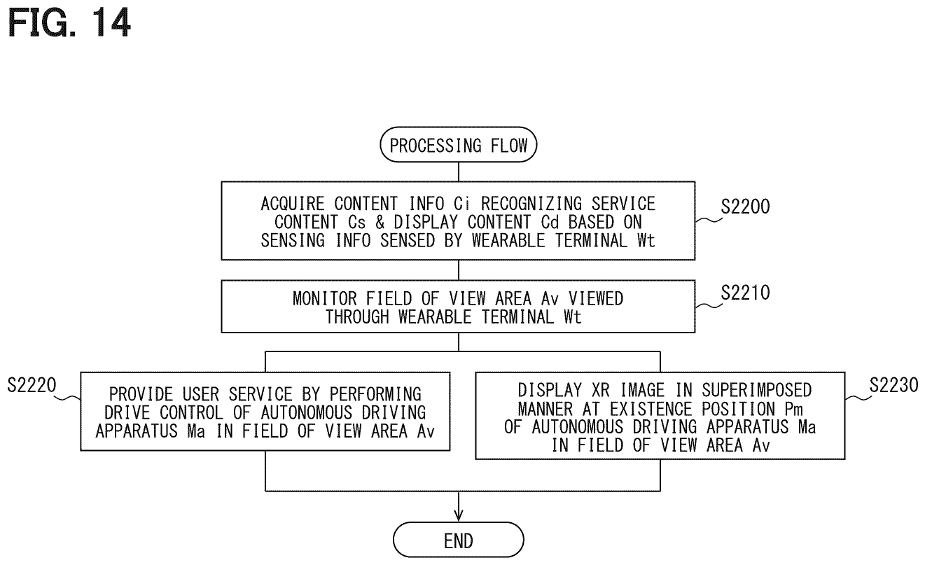

The functional blocks of the control system 2020, which perform service related process, include a recognition block 2200, a monitoring block 2210, a drive control block 2220, and a display control block 2230, as shown in FIG. 13. The processing method in which the processing system 2001 executes service related process through cooperation of the functional blocks 2200, 2210, 2220, and 2230 is executed according to the processing flow shown in FIG. 14. The processing flow is executed in response to the sensor unit 2003 of the wearable terminal Wt acquiring, as the sensing information, a service request input indicating an intention of user Us to request the provision of user service. The symbol “S” in the processing flow represents each step executed by an instruction included in the processing program of the second embodiment.

In S2200 of the processing flow, the recognition block 2200 (see FIG. 13) acquires content information Ci that recognizes the service content Cs and display content Cd intended by the user Us, based on the sensing information related to the face of the user Us who wears the wearable terminal Wt on the face. The sensing information is input to the sensor unit 2003 as the intention of user, and is acquired through the wearable terminal Wt. The display unit 2002 of the wearable terminal Wt may superimpose an input acceptance image 2b conforming to the first embodiment on the real image of the field of view area Av to accept line of sight input corresponding to a change in the direction of line of sight or facial expression input corresponding to a change in facial expression as a selection input of content Cs, Cd from the user Us to the sensor unit 2003. Except for the above points, S2200 is executed in similar manner to S200 of the first embodiment.

In S2210 of the processing flow shown in FIG. 14, the monitoring block 2210 (see FIG. 13) monitors the field of view area Av visually recognized by the user Us through the wearable terminal Wt. The field of view area Av is monitored in a service space As in an information accumulation target space in which multiple voxels Vi are set by the infrastructure system Is, where a user service of a type corresponding to the service content Cs is provided as shown in FIG. 12. Therefore, based on at least one of the sensing information from the sensor unit 2003 of the wearable terminal Wt, such as camera information and inertial information, monitoring of the field of view area Av extending through, for example, glasses or lenses, in the direction of the user's face or line of sight, or in the direction of the wearable terminal Wt, is performed.

In S2220 of the processing flow shown in FIG. 14, the drive control block 2220 (see FIG. 13) provides a user service of a type corresponding to the service content Cs out of the content information Ci by controlling the traveling of the autonomous driving apparatus Ma in the current field of view Av. Except for this point, S2220 is executed in similar manner to S220 of the first embodiment.

The following will describe S2230 executed in parallel with S2220 in the processing flow shown in FIG. 14. In S2230, the display control block 2230 (see FIG. 13) displays the XR image 2a corresponding to the display content Cd out of the content information Ci in a superimposed manner at the position Pm of the autonomous driving apparatus Ma, as shown in FIG. 12, on the wearable terminal Wt where the autonomous driving apparatus Ma providing a user service by S2220 exists in the field of view Av. The superimposed display position of the XR image 2a is adjusted to match the existence position Pm in the field of view Av in accordance with the drive control pattern of the autonomous driving apparatus Ma in S2220. As a result, in the field of view Av, the XR image 2a is displayed in a three-dimensional superimposed manner overlapping the entire autonomous driving apparatus Ma at the existence position Pm, obscuring it opaquely or semi-transparently from in front of the autonomous driving apparatus.

In S2230, the display control block 2230 also superimposes and displays the XR image 2d, as shown in FIG. 12, on the existence position Po of another object Oo that exists in the field of view Av together with the autonomous driving apparatus Ma. The superimposed display position of the XR image 2d is adjusted according to the position Po of another object Oo. In this way, another object Oo whose existence position Po in the field of view area Av is overlapped with the XR image 2d is at least one of the following: a person other than the user Us of the processing system 2001, a moving body other than the autonomous driving apparatus Ma cooperating with the processing system 2001, and a planimetric feature, or the like.

Except for the above point, S2230 is executed in similar manner to S230 in the first embodiment. In various user services using S2230 conforming to the first embodiment, XR images 2a, 2d that are visually recognized at least superimposed on the position Pm of the autonomous driving apparatus Ma and the position Po of the periphery object Oo are displayed and output to the user Us.

In the processing flow of the second embodiment shown in FIG. 14, when the provision of the user service according to the service content Cs out of the content information Ci is completed in S2220 or S2230, the current execution is completed. Thereafter, in response to the next service request input being acquired through the sensor unit 2003 of the wearable terminal Wt, the next execution of the processing flow is started.

### Effects

The effects of the second embodiment explained so far will be described below.

According to the second embodiment, content information Ci that recognizes service content Cs intended by the user Us is acquired based on the sensing information of the wearable terminal Wt worn by the user Us. The field of view area Av viewed by the user Us through the wearable terminal Wt is monitored. Then, a user service of a type corresponding to the service content Cs is provided in the current field of view area Av by controlling the driving of the autonomous driving apparatus Ma. Thus, even among the diversified user services, it is possible to provide a user service that satisfies the user's preferences by cooperating with the autonomous driving apparatus Ma.

According to the second embodiment, the content information Ci that recognizes the display content Cd the user Us intends to display is also acquired based on the sensing information of the mobile terminal Mt. In the wearable terminal Wt in which the autonomous driving apparatus Ma providing the user service as described above exists in the field of view area Av, the XR image 2a corresponding to the display content Cd is displayed in superimposed manner on the position Pm of the autonomous driving apparatus Ma. This means that it is possible to increase the satisfaction of the user's preferences by superimposing the XR image 2a according to the display content Cd that matches the service content Cs provided by the autonomous driving apparatus Ma.

According to the second embodiment, the XR image 2d is also superimposed and displayed on the existence position Po of another object Oo that exists in the field of view Av together with the autonomous driving apparatus Ma. This configuration enables superimposed display of XR images 2a, 2d corresponding to display content Cd that matches the service content Cs provided by the autonomous driving apparatus Ma over a wide range of the field of view area Av, thereby increasing user experience.

According to the second embodiment, the content information Ci is acquired based on the sensing information related to the face of user Us on which the wearable terminal Wt is worn. According to this configuration, the service content Cs and the display content Cd intended by the user Us as the content information Ci can be automatically recognized from the face on which the wearable terminal Wt is worn. Thus, it is possible to improve the user convenience, thereby improving the user experience.

According to the second embodiment, three-dimensional spatial information Ti to which position related information relating to each of the positions Pm, Po of the autonomous driving apparatus Ma and another Oo is added is obtained from the infrastructure database Di for multiple three-dimensional voxels Vi virtually divided into the service space As in which user services are provided. Therefore, at respective positions Pm, Po of the autonomous driving apparatus Ma and another object Oo based on the acquired three-dimensional spatial information Ti, the XR images 2a, 2d that can satisfy the user preferences in the field of view Av can be displayed in superimposed manner on the display by appropriately overlapping the images from a nearby position. Thus, it is possible to further improve user experience while suppressing the discomfort felt by the user due to misalignment of the superimposed display.

According to the second embodiment, the user service is provided by a drive control pattern of the autonomous driving apparatus Ma that is matched to the service content Cs out of the content information Ci. This configuration further improves user experience through operation of the autonomous driving apparatus Ma in coordination with the user service. Additionally, according to the second embodiment, the superimposed display position of the XR image 2a with respect to the field of view area Av is adjusted in accordance with the position Pm of the autonomous driving apparatus Ma that follows the drive control pattern. According to this configuration, the XR image 2a corresponding to the display content Cd that matches the service content Cs can be superimposed on the field of view area Av in accordance with the operation of autonomous driving apparatus Ma, thereby enabling further improvement of user experience. In the second embodiment, by being based on three-dimensional spatial information Ti from the infrastructure database Di, the tracking ability of the XR image 2a in response to the operation of the autonomous driving apparatus Ma can be improved, and it is also possible to improve the effect of suppressing user discomfort caused by positional misalignment of the superimposed display.

According to the second embodiment, character images related to the display content Cd out of the content information Ci are superimposed and displayed as the XR images 2a and 2d on the positions Pm and Po of the autonomous driving apparatus Ma and another object Oo. This configurations enables the character image that can satisfy the user's preferences in the field of view area Av to be overlapped in front of the autonomous driving apparatus Ma and another object Oo and be visible to the user Us. Therefore, it is possible to increase the degree of satisfaction of the user's preferences, particularly with respect to the display content Cd.

### Other Embodiments

While multiple embodiments are described above, the present disclosure is not interpreted as being limited to the embodiments and can be applied to various embodiments and combinations without departing from a spirit of the present disclosure.

In a modification of the first and second embodiments, the dedicated computer constituting the control system 20, 2020 of the processing system 1, 2001 may have at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In a modification of the first and second embodiments, the processing system 1, 2001 may be disconnected from the infrastructure system Is. In this case, the sensing information sensed by the connection elements Mt, Ma, and Wt with the processing systems 1 and 2001 may be used instead of the three-dimensional spatial information Ti acquired from the infrastructure database Di.

In a modification of the first and second embodiments, three-dimensional spatial information Ti that is not linked to a voxel Vi may be acquired by the processing system 1, 2001 from the infrastructure database Di. In a modification of the first and second embodiments, two-dimensional grid information may be acquired by the processing system 1, 2001 from the infrastructure database Di instead of the three-dimensional spatial information Ti.

In a modification of the first embodiment, a smart watch or a video see-through or non-transparent wearable terminal may be used as the mobile terminal Mt. In a modification of the second embodiment, when a mobile terminal Mt is connected to a processing system 2001 and functions as part of a wearable terminal Wt, a processing flow may be executed in response to the sensor unit 3 that constitutes that part acquiring a service request input as sensing information. In a modification of the second embodiment, when a mobile terminal Mt is connected to a processing system 2001 and functions as part of a wearable terminal Wt, content information Ci that recognizes service content Cs and display content Cd at S2200 of the processing flow may be obtained based on sensing information of a sensor unit 3 that constitutes part of the mobile terminal Mt.

In a modification of S230 in the first embodiment and S2230 in the second embodiment, the XR image 2d does not need to be superimposed on the existence position Po of another object Oo that exists in the area Ab, Av together with the autonomous driving apparatus Ma. In a modification of S2200 of the second embodiment, a gesture input or a voice input by the user Us may be sensed by the sensor unit 2003 in accordance with S200 of the first embodiment. In a modification of S2200 of the second embodiment, similar to S200 of the first embodiment, gesture input, gaze input, facial expression input, or voice input by the user Us may be recognized based on three-dimensional spatial information Ti obtained from the infrastructure database Di.

In addition to the embodiments and modifications described above, the processing system 1, 2001 having at least one processor 24 and at least one memory 22 in the control system 20, 2020 may be implemented in the form of a semiconductor device (for example, a semiconductor chip or the like.)

What is claimed is:

1. A processing system comprising
at least one processor that executes a service related process related to a user service provided to a user,
wherein
the at least one processor:
acquires content information that recognizes a service content and a display content corresponding to an intention of the user based on sensing information sensed by a mobile terminal carried by the user;
monitors a background area that configures a display background of the mobile terminal when the user is oriented to the mobile terminal; and
provides the user service having a type corresponding to the service content out of the content information by performing a driving control of an autonomous driving apparatus in the background area currently displayed, and
the at least one processor controls the mobile terminal to:
display a background video of the background area in which the autonomous driving apparatus that provides the user service exists; and
display, in a superimposed manner, a cross reality image corresponding to the display content out of the content information at an existence position of the autonomous driving apparatus in the background video.

2. The processing system according to claim 1, wherein
the mobile terminal superimposes another cross reality image at an existence position of another object that exists in the background area of the mobile terminal, in addition to the cross reality image of the autonomous driving apparatus.

3. A processing system comprising
at least one processor that executes a service related process related to a user service provided to a user,
wherein
the at least one processor:
acquires content information that recognizes a service content and a display content corresponding to an intention of the user based on sensing information sensed by a wearable terminal worn by the user;
monitors a field of view area viewed by the user through the wearable terminal; and
provides the user service having a type corresponding to the service content out of the content information by performing a driving control of an autonomous driving apparatus in the field of view area currently displayed, and
when the autonomous driving apparatus providing the user service exits in the field of view, the at least one processor controls the wearable terminal to display, in a superimposed manner, a cross reality image corresponding to the display content out of the content information at an existence position of the autonomous driving apparatus.

4. The processing system according to claim 3, wherein
the at least one processor controls the wearable terminal to superimpose another cross reality image at an existence position of another object that exists the field of view area of the wearable terminal, in addition to the cross reality image of the autonomous driving apparatus.

5. The processing system according to claim 3, wherein
the at least one processor acquires the content information based on the sensing information, which is related to a face of the user on which the wearable terminal is worn.

6. The processing system according to claim 1, wherein
the at least one processor acquires, from an infrastructure database, three-dimensional spatial information, which is generated by adding position related information of the existence position to multiple three-dimensional voxels of a service space,
the service space is defined as a space in which the user service is provided and the multiple three-dimensional voxels are generated by virtually dividing the service space, and
the at least one processor controls the mobile terminal to superimpose and display the cross reality image on the existence position based on the three-dimensional spatial information.

7. The processing system according to claim 1, wherein
the at least one processor provides the user service according to a drive control pattern of the autonomous driving apparatus, which matches the service content out of the content information.

8. The processing system according to claim 7, wherein
the at least one processor controls the mobile terminal to adjust a superimposed display position of the cross reality image in accordance with the existence position according to the drive control pattern.

9. The processing system according to claim 6, wherein
the at least one processor provides the user service according to a drive control pattern of the autonomous driving apparatus, which matches the service content out of the content information, and
the at least one processor controls the mobile terminal to adjust a superimposed display position of the cross reality image in accordance with the existence position according to the drive control pattern.

10. The processing system according to claim 1, wherein
the at least one processor controls the mobile terminal to superimpose a character image related to the display content out of the content information on the existence position as the cross reality image.

11. A processing method executed by at least one processor to execute a service related process related to a user service provided to a user, the processing method comprising:
acquiring content information that recognizes a service content and a display content corresponding to an intention of the user based on sensing information sensed by a mobile terminal carried by the user;
monitoring a background area that configures a display background of the mobile terminal when the user is oriented to the mobile terminal;
providing the user service having a type corresponding to the service content out of the content information by performing a driving control of an autonomous driving apparatus in the background area currently displayed; and
displaying, on the mobile terminal, a cross reality image in a superimposed manner at an existence position of the autonomous driving apparatus in a background video, which indicates the background area in which the autonomous driving apparatus that provides the user service exists, the cross reality image corresponding to the display content out of the content information.

12. A processing method executed by at least one processor to execute a service related process related to a user service provided to a user, the processing method comprising:
acquiring content information that recognizes a service content and a display content corresponding to an intention of the user based on sensing information sensed by a wearable terminal worn by the user;
monitoring a field of view area viewed by the user through the wearable terminal;
providing the user service having a type corresponding to the service content out of the content information by performing a driving control of an autonomous driving apparatus in the field of view area currently displayed; and
displaying, on the wearable terminal, a cross reality image in a superimposed manner at an existence position of the autonomous driving apparatus in the field of view area of the wearable terminal in which the autonomous driving apparatus exists, the cross reality image corresponding to the display content out of the content information.

13. A computer-readable non-transitory storage medium storing a processing program including instructions to be executed by at least one processor, the at least one processor executing a service related process related to a user service provided to a user by executing the instructions of the processing program, the instructions comprising:
acquiring content information that recognizes a service content and a display content corresponding to an intention of the user based on sensing information sensed by a mobile terminal carried by the user;
monitoring a background area that configures a display background of the mobile terminal when the user is oriented to the mobile terminal;
providing the user service having a type corresponding to the service content out of the content information by performing a driving control of an autonomous driving apparatus in the background area currently displayed; and
displaying, on the mobile terminal, a cross reality image in a superimposed manner at an existence position of the autonomous driving apparatus in a background video, which indicates the background area in which the autonomous driving apparatus that provides the user service exists, the cross reality image corresponding to the display content out of the content information.

14. A computer-readable non-transitory storage medium storing a processing program including instructions to be executed by at least one processor, the at least one processor executing a service related process related to a user service provided to a user by executing the instructions of the processing program, the instructions comprising:
acquiring content information that recognizes a service content and a display content corresponding to an intention of the user based on sensing information sensed by a wearable terminal worn by the user;
monitoring a field of view area viewed by the user through the wearable terminal;
providing the user service having a type corresponding to the service content out of the content information by performing a driving control of an autonomous driving apparatus in the field of view area currently displayed; and
displaying, on the wearable terminal, a cross reality image in a superimposed manner at an existence position of the autonomous driving apparatus in the field of view area of the wearable terminal in which the autonomous driving apparatus exists, the cross reality image corresponding to the display content out of the content information.
